(19) United States
(12) Patent Application Publication
(10) Pub. No.: US 2006/0077326 A1
(43) Pub. Date: Apr. 13, 2006

(54) Retardation-film integrated polarizing plate and method of manufacturing the same

(75) Inventors: Kuniaki Ishibashi, Osaka (JP); Hiroyuki Yoshimi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/244,069

(22) Filed: Oct. 6, 2005

(30) Foreign Application Priority Data
Oct. 7, 2004 (JP) 2004-294608
Feb. 10, 2005 (JP) 2005-034644

(51) Int. Cl. G02F 1/1335

(52) U.S. Cl. 349/117

(57) ABSTRACT

A retardation-film integrated polarizing plate includes a polarizing plate stretched in a lengthwise direction thereof and having an absorption angle in the lengthwise direction, and a uniaxial retardation film having a slow axis in a widthwise direction thereof and an Nz coefficient of 0.9-1.1, in which the polarizing plate is laminated with the uniaxial retardation film so as to have the slow axis of the retardation film oriented at an angle of 90 degrees plus or minus 5 degrees to the absorption axis of the polarizing plate. The thus arranged polarizing plate is capable of enhancing the front contrast and the contrast at oblique viewing angles.

### CROSS REFERENCE TO RELATED APPLICATION

This application claims priority from Japanese Patent Application Nos. 2004-294608 and 2005-034644, which are incorporated herein by reference.

### BACKGROUND OF THE INVENTION

1. Field of the Invention

The present invention relates to a retardation-film integrated polarizing plate and a method of manufacturing the same.

2. Discussion of the Background

Hitherto, a retardation film is used for a variety of liquid crystal display (LCD) devices in order to improve the image display quality through compensation for the hue coloring or widening the viewing angle. This retardation film is generally prepared with its retardation controlled by a stretching process such as a uniaxial or biaxial stretching process.

In order to prepare a retardation-film integrated polarizing plate for use in a variety of LCD devices by laminating a retardation film with a polarizing plate, it is necessary to have a slow axis of the retardation film oriented substantially at right angles to an absorption axis of the polarizing plate. In general, a polarizing plate is formed by using an elongated polarizing film, which is stretched in a lengthwise direction so as to have an absorption axis in a stretching direction or the lengthwise direction. Accordingly, when a polarizing plate is laminated with a retardation film in successive manner, it is necessary to previously have the slow axis oriented in a widthwise direction of the elongated retardation film.

However, in manufacturing the aforesaid retardation film, a so-called bowing phenomenon is likely to be caused when successively stretching a polymer film in a widthwise direction to have retardation in the film, which phenomenon skews the in-plane orientation axis in the widthwise direction to the form of a bow. Therefore, it is difficult to uniformly cause the orientation axis, the birefringence and the retardation to a film by the stretching in the widthwise direction. Where such a retardation film is laminated with a polarizing plate, hue coloring in image or narrowed viewing angle may be caused, which results in difficulty in enhancing the image display quality by enhancing the front contrast or the contrast at oblique viewing angles. Therefore, there is a great demand for a retardation-film integrated polarizing plate that is capable of enhancing the display quality of an LCD device or the like, which involves enhancing the front contrast and the contrast at oblique viewing angles.

It is an object of the present invention to provide a retardation-film integrated polarizing plate that is capable of enhancing the image display quality of an LCD device or the like by enhancing the front contrast and the contrast at oblique viewing angles.

### SUMMARY OF THE INVENTION

As a result of intentional and repeated studies by the present inventors, it was found that the above object can be achieved by laminating a uniaxial retardation film having a slow axis oriented in a widthwise direction thereof and a given Nz coefficient, with a polarizing plate stretched in a lengthwise direction and having an absorption axis oriented in the lengthwise direction, so as to have the slow axis of the retardation film oriented at a given angle to the absorption angle of the polarizing plate. Hence, the present invention has been achieved.

According to one aspect of the present invention, there is provided a retardation-film integrated polarizing plate that includes a polarizing plate stretched in a lengthwise direction thereof and having an absorption angle in the lengthwise direction, and a uniaxial retardation film having a slow axis in a widthwise direction thereof and an Nz coefficient of 0.9-1.1, in which the polarizing plate is laminated with the uniaxial retardation film so as to have the slow axis of the retardation film oriented at an angle of 90 degrees plus or minus 5 degrees to the absorption axis of the polarizing plate. Herein, the Nz coefficient is represented by Nz=(nx−nz)/(nx−ny), in which nx: maximum in-plane refractive index, ny: refractive index in a direction crossing at right angles to an in-plane nx direction that gives the maximum in-plane refractive index, and nz: refractive index in a direction crossing at right angles to a refractive index angle of nx and a refractive index angle of ny and a thicknesswise refractive index, the nx direction being a stretching direction (widthwise direction).

It is possible to produce an effect of enhancing the front contrast and the contrast at oblique viewing angles when the retardation-film integrated polarizing plate is used in an LCD display device or the like, in which the retardation-film integrated polarizing plate is provided by laminating the uniaxial retardation film having orientation angles of the slow axis uniform to the widthwise direction of the film and having an Nz coefficient of 0.9-1.1, with the polarizing plate stretched in the lengthwise direction and having the absorption axis in the lengthwise direction, so as to have the slow axis of the retardation film crossing substantially at right angles to the absorption angle of the polarizing plate.

In the present invention, an in-plane retardation And of the retardation film is preferably 10-590 nm. With the in-plane retardation being within this range, it is possible to compensate for the viewing angle corresponding to a variety of driving modes for an LCD device.

According to another aspect of the present invention, there is provided a method of manufacturing a retardation-film integrated polarizing plate that includes laminating a uniaxial retardation film having a slow axis in a widthwise direction thereof and an Nz coefficient of 0.9-1.1, with a polarizing plate stretched in a lengthwise direction thereof and having an absorption angle in the lengthwise direction so as to have opposite lateral sides (longitudinal edges) of the retardation film respectively positioned parallel to opposite lateral sides (longitudinal edges) of the polarizing plate, thereby allowing the slow axis of the retardation film to be oriented at an angle of 90 degrees plus or minus 5 degrees to the absorption axis of the polarizing plate. By providing an LCD device with the retardation-film integrated polarizing plate, which is obtained by laminating the retardation film with the polarizing plate so as to have the opposite lateral sides (longitudinal edges) of the retardation film respectively positioned parallel to the opposite lateral sides (longitudinal edges) of the polarizing plate, thereby allowing the slow axis of the retardation film oriented at an angle of 90 degrees plus or minus 5 degrees to the absorption axis of the polarizing plate, it is possible to enhance the display quality such as by enhancing the front contrast and the contrast at oblique viewing angles.

Thus, it is possible to enhance the front contrast and the contrast at oblique viewing angles, as well as compensating for the hue coloring or widening the viewing angle.

### BRIEF DESCRIPTION OF THE DRAWINGS

The above, and other objects, features and advantages of the present invention will become apparent from the detailed description thereof in conjunction with the accompanying drawings wherein.

FIG. 1 is a sectional view of a liquid crystal panel with a retardation-film integrated polarizing plate mounted therein used in Evaluation Tests.

### DETAILED DESCRIPTION OF THE PREFERRED EMBODIMENT

An embodiment according to the present invention will be hereinafter described with reference to the accompanying drawings.

A retardation-film integrated polarizing plate of the present invention includes a uniaxial retardation film having a slow axis in a widthwise direction thereof and an Nz coefficient of 0.9-1.1 and a polarizing plate stretched in a lengthwise direction thereof and having an absorption axis in the lengthwise direction. They are laminated together so as to have the slow axis of the retardation film oriented at an angle of 90 degrees plus or minus 5 degrees to the absorption axis of the polarizing plate. Herein, the Nz coefficient is represented by Nz=(nx−nz)/(nx−ny), in which nx: maximum in-plane refractive index, ny: refractive index in a direction crossing at right angles to an in-plane nx direction that gives the maximum in-plane refractive index, and nz: refractive index in a direction crossing at right angles to a refractive index angle of nx and a refractive index angle of ny and thicknesswise refractive index.

Now, the description will be made for a retardation film of this embodiment. The retardation film of this embodiment has a slow axis in a widthwise direction thereof and an Nz coefficient of 0.9-1.1. The retardation film having the slow axis in the widthwise direction thereof is prepared by stretching a polymer film in the widthwise direction, while at the same time shrinking the same in the lengthwise direction so as to satisfy the relational expression: (1/STD)^{1/2}≦SMD<1, in which the length in the widthwise direction and the length in the lengthwise direction, of the polymer film before being stretched are respectively designated as 1, and STD represents a change ratio of the length in the widthwise direction of the polymer film due to stretching and SMD represents a change ratio of the length in the lengthwise direction of the polymer film due to shrinking.

In this embodiment, while the stretching ratio of the lengthwise direction (MD) of a polymer film subsequently varies depending on the stretching ratio of the widthwise direction (TD), it is preferable to have SMD within the range of (1/STD)^{1/2}−(1/STD)^{1/2}×1.05 in the relative expression of (1/STD)^{1/2}≦SMD<1, in which STD represents a change ratio of the length in the widthwise direction of the polymer film due to stretching and SMD represents a change ratio of the length in the lengthwise direction of the polymer film due to shrinking. When in “SMD=1”, that is, when the length in the lengthwise direction is not changed, it is not possible to solve a problem to cause the bowing phenomenon. When in “(1/STD)^{1/2}>SMD”, there still remains a problem to cause wrinkling in the widthwise direction.

A stretching treatment and a shrinking treatment which are to be made simultaneously can be directly applied independently to a polymer film. Or, it is also possible to indirectly apply the stretching and shrinking treatments to a polymer film, which is laminated on a substrate to have a laminate, by holding the opposite ends of the substrate of the laminate and simultaneously applying the stretching and shrinking treatments to the substrate. Further, the simultaneous application of the stretching and shrinking treatments is possible to be made for a laminate, which is prepared by laminating a polymer film on a substrate, by holding the opposite ends of the laminate.

Examples of the polymer film used include polycarbonate type resin, cellulose type resin and norbornene type resin.

The polymer film preferably has light transmittance or the like, and, for example, preferably has a light transmittance of 85% or more and more preferably 90% or more. It is also preferable to cause less irregular orientation.

Examples of the norbornene type resin include: (1) a resin obtained by hydrogenating a ring-opened (co)polymer of norbornene type monomer after polymer denaturation such as addition of maleic acid, addition of cyclopentadiene, according to needs and circumstances; (2) a resin obtained by addition polymerization of a norbornene type monomer; (3) a resin obtained by addition polymerization of a norbornene type monomer and an olefin type monomer such as ethylene or α-olefin; and so on. Polymerization methods and hydrogenating methods may be made following the conventional procedures.

Examples of the norbornene type monomer include: norbornene, and its alkyl and/or alkylidene-substituted compounds thereof, such as 5-methyl-2-norbornene, 5-dimethyl-2-norbornene, 5-ethyl-2-norbornene, 5-butyl-2-norbornene, 5-ethylidene-2-norbornene, polar radical-substituted compounds, or polar substituents thereof such as a halogen; dicyclopentadiene, 2, 3-dihydrodicyclopentadiene or the like; dimethanooctahydronaphthalene, and alkyl and/or alkylidene-substituted compound thereof, or polar substituents thereof such as a halogen, such as 6-methyl-1, 4:5, 8-dimethanol-1, 4, 4a, 5, 6, 7, 8, 8a-octahydronaphthalene, 6-ethyl-1, 4:5, 8-dimethanol-1, 4, 4a, 5, 6, 7, 8, 8a-octahydronaphthalene, 6-ethylidene-1, 4:5, 8-dimethanol-1, 4, 4a, 5, 6, 7, 8, 8a-octahydronaphthalene, 6-chloro-1, 4:5, 8-dimethanol-1, 4, 4a, 5, 6, 7, 8, 8a-octahydronaphthalene, 6-cyano-1, 4:5, 8-dimethano-1, 4, 4a, 5, 6, 7, 8, 8a-octahydronaphthalene, 6-pyridyl-1, 4:5, 8-dimethanol-1, 4, 4a, 5, 6, 7, 8, 8a-octahydronaphthalene, 6-methoxycarbonyl-1, 4:5, 8-dimethanol-1, 4, 4a, 5, 6, 7, 8, 8a-octahydronaphthalene, or the like; trimers and tetramers of cyclopentadiene such as 4, 9:5, 8-dimethano-3a, 4, 4a, 5, 8, 8a, 9, 9a-octahydro-1H-benzonindene, 4, 11:5, 10:6, 9-trimethanol-3a, 4, 4a, 5, 5a, 6, 9, 9a, 10, 10a, 11, 11a-dodecahydro-1H-cyclopentaanthracene.

The norbornene type resin generally has a number average molecular weight (Mn) ranging from 25,000-200,000, preferably from 30,000 to 100,000, and more preferably from 40,000 to 80,000, as measured by gel permeation chromatography (GPC) using toluene as a solvent. When the number average molecular weight falls within the above ranges, it is possible to have a norbornene type resin that is excellent in mechanical strength, solubility, moldability and processability for flow casting.

When the norbornene type resin is obtained by hydrogenating a ring-opened polymer of norbornene type monomer, the hydrogenating rate of the norbornene type resin used is generally 90% or more, preferably 95% or more and more preferably 99% or more in light of thermal degradation and light degradation.

As the polycarbonate type resin, an aromatic polycarbonate, which comprises an aromatic dihydric phenol component and a carbonate component. An aromatic polycarbonate can be obtained generally by the reaction of an aromatic dihydric phenol with a carbonate precursor. Specifically, an aromatic polycarbonate can be obtained by the phosgene process which involves blowing of phosgene into an aromatic dihydric phenol compound in the presence of caustic alkali and solvent, or by the ester exchange process which involves ester exchanging in the presence of a catalyst between an aromatic dihydric phenol compound and a bisaryl carbonate. Herein, examples of the carbonate precursor include phosgene, and bischloro-formate, diphenylcarbonate, di-p-trylcarbonate, phenyl-p-trylcarbonate, di-p-chlorophenylcarbonate or dinaphtylcarbonate, of the dihydric phenols. Of them, phosgene and diphenylcarbonate are preferable.

Examples of the aromatic dihydric phenol compound to be reacted with the carbonate precursor include 2,2-bis(4-hydroxyphenyl)propane, 2,2-bis(4-hydroxy-3,5-dimethylphenyl)propane, bis(4-hydroxyphenyl)methane, 1,1-bis(4-hydroxyphenyl)ethane, 2,2-bis(4-hydroxyphenyl)butane, 2,2-bis(4-hydroxy-3,5-dimethylphenyl)butane, 2,2-bis(4-hydroxy-3,5-dipropylphenyl)propane, 1,1-bis(4-hydroxyphenyl)cyclohexane, 1,1-bis(4-hydroxyphenyl)-3,3,5-trimethylcyclohexane. These may be used alone or in combination of two or more thereof. Of them, 2,2-bis(4-hydroxyphenyl)propane, 1,1-bis(4-hydroxyphenyl)cycrohexane, 1,1-bis(4-hydroxyphenyl)-3,3,5-trimethylcyclohexane are preferable. Further, 2,2-bis(4-hydroxyphenyl)propane is more preferable. Particularly, it is preferable to use 2,2-bis(4-hydroxyphenyl)propane in combination with 1,1-bis(4-hydroxyphenyl)-3,3,5-trimethylcyclohexane.

When 2,2-bis(4-hydroxyphenyl)propane, 1,1-bis(4-hydorxyphenyl)-3,3,5-trimethylcyclohexane are used in combination, it is possible to adjust Tg (glass-transition temperature), photoelastic coefficient or the like, of a polymer film by changing the proportion of the components.

It is possible to increase Tg and decrease the photoelastic coefficient by increasing the content of 1,1-bis(4-hydroxyphenyl)-3,3,5-trimethylcyclohexane in a polycarbonate type resin. It is preferable to contain 1,1-bis(4-hydroxyphenyl)-3,3,5-trimethylhexane and 2,2-bis(4-hydroxyphenyl)propane in a polycarbonate type resin in the proportion of generally 8:2 to 2:8, preferably 8:2 to 4:6, more preferably 7:3 to 5:5, and most preferably 6:4.

The number average molecular weight (Mw) of the polycarbonate type resin is in the range of generally 25,000-200,000, preferably 30,000-150,000, more preferably 40,000-100,000, and most preferably 50,000-80,000. It is possible to obtain a retardation film having excellent mechanical strength and reliability by having the number average molecular weight of the polycarbonate resin falling within the above ranges.

It is not necessary to limit the cellulose type resin to a specific one, provided that it is any ester of cellulose with an acid. Of them, preferably used is ester of cellulose with fatty acid, such as cellulose triacetate, cellulose diacetate, cellulose tripropionate and cellulose dipropionate. When in use for optics, cellulose triacetate among them is preferable in light of low birefringence and high transmittance. Examples of commercially available cellulose triacetate include “UV-50”, “SH-50”, “UV-80”, “SH-80”, “TD-80U”, “TD-TAC” and “UZ-TAC” manufactured by Fuji Photo Film Co., Ltd., “Cellulose Triacetate 80 μm Series” manufactured by Konica Corporation, and “Cellulose Triacetate 80 μm Series” manufactured by Lonza Japan Ltd.

On the other hand, as the substrate on which the polymer film is laminated, a light transmissive film, which can be stretched and shrunk, is preferable, and a film, which does not cause retardation even after being stretched, is particularly preferable from the view point of practical use. Particularly, a film, which has an excellent transmittivity, is preferable, since it is possible to directly use a laminate of the substrate and a retardation film formed thereon, as an optical film. As the substrate, a previously stretched film or a heat shrinkable film is preferable in order to smoothly carry out the shrinking in the lengthwise direction. For example, a thermoplastic resin is preferable as a material thereof.

Examples of a material from which the substrate is made include polyethylene, polypropylene, polyolefin such as poly(4-methylpentine-1), polyimide, polyamideimide, polyamide, polyetherimide, polyetheretherketone, polyketonsulfide, polyethersulfone, polysulfone, polyphenylenesulfide, polyphenyleneoxide, polyethyleneterephthalate, polybutyleneterephthalate, polyethylenenaphthalate, polyacetal, polyarylate, acrylic resin, polyvinylalcohol, polypropylene, epoxy resin, phenol resin and the like, polyester resin, acrylic resin, polystyrene resin, polyvinyl alcohol resin, polyvinyl chloride resin, polyvinylidene chloride resin, polyacryl resin, or a mixture thereof. A liquid crystal polymer is also usable. Of them, it is preferable to use polypropylene, polyethyleneterephthalate, polyethylenenaphthalate and the like in light of solvent resistance, heat resistance and so on. Moreover, it is possible to use a mixture as described in Japanese Patent Application Publication No. 2001-343529 (WO 01/37007), which includes a thermoplastic resin whose side chain has a substituted or unsubstituted imido group and a thermoplastic resin whose side chain has a substituted or unsubstituted phenyl group and nitrile group, for example, a resin composition containing an alternating copolymer of isobutene and N-methyl maleimide and an acrylonitrile-styrene copolymer. Of these materials, it is preferable to use, for example, the aforesaid mixture of a thermoplastic resin whose side chain has a substituted or unsubstituted imido group and a thermoplastic resin whose side chain has a substituted or unsubstituted phenyl group and nitrile group.

A retardation film of this embodiment has a slow axis in the widthwise direction thereof and an Nz coefficient of 0.9-1.1 and preferably 0.95-1.05. When the Nz coefficient is less than 0.9, the film is wrinkled and therefore is hard to be used as an optical film. When the Nz coefficient exceeds 1.1, the viewing angle of an LCD panel with the film mounted therein may be decreased.

Herein, the Nz coefficient is represented by Nz=(nx−nz)/(nx−ny), in which nx: maximum in-plane refractive index, ny: refractive index in a direction crossing at right angles to an in-plane nx direction that gives the maximum in-plane refractive index, and nz: refractive index in a direction crossing at right angles to a refractive index angle of nx and a refractive index angle of ny and thicknesswise refractive index, the nx direction being a stretching direction (widthwise direction).

That is, the Nz coefficient can be determined by Rth/Δnd from the in-plane retardation (Δnd=(nx−ny)×d) and the thicknesswise retardation (Rth=(nx−nz)×d), in which nx, ny and nz respectively represent refractive indexes in an X axis (slow axis), a Y axis and a Z axis, of the retardation film, the X axis being an axis that gives a maximum in-plane refractive index, the Y axis being an in-plane axis perpendicular to the X axis, the Z axis representing a thickness direction perpendicular to the X axis and the Y axis, and d represents the thickness of the retardation film.

The in-plane retardation (Δnd) of the retardation film of this embodiment is 10-590 nm and preferably 20-300 nm, as measured on the basis of light at a wavelength of 590 nm. When the in-plane retardation falls within these ranges, it is possible to produce an effect of allowing for compensation of the viewing angle corresponding to a variety of driving modes for an LCD device.

Now, the description will be made for a method of manufacturing the retardation film of this embodiment.

First, a polymer film, to which stretching and shrinking treatments are to be applied, is prepared. The thickness of the polymer film is not limited to a specific thickness and can be varied depending on a desirable retardation of a retardation film to be manufactured, a material of the polymer film or the like. The thickness is in the range of generally 5-500 μm, preferably 10-350 μm and more preferably 20-200 μm. When the thickness falls within these ranges, the film exhibits a sufficient mechanical strength so that it is hardly cut or damaged during the stretching and shrinking treatments. The length in the lengthwise direction and the thickness in the widthwise direction are not necessarily limited but can be varied depending on the size of a stretching machine or the like to be used.

The polymer film is simultaneously subjected to the stretching treatment in the widthwise direction and the shrinking treatment in the lengthwise direction so as to satisfy the relational expression: (1/STD)^{1/2}≦SMD<1. These stretching and shrinking treatments respectively in the widthwise direction and the lengthwise direction can be made by using for example a biaxial stretching machine, such as a high-performance thin-film machine (trade name FITZ, manufactured by K.K. Ichikin Kogyo-sha) that can automatically perform the aforesaid stretching and shrinking operations. This machine allows for the settings of the desired stretching ratio of a vertical direction (the lengthwise direction of the film=the moving direction of the film) and the desired shrinking ratio of the widthwise direction (a widthwise direction=a direction perpendicular to the moving direction of the film) as well as the setting of the desired shrinking ratio of the vertical direction (lengthwise direction), and thus is capable of simultaneously performing the stretching operation and the shrinking operation respectively in given conditions. It is possible to use a biaxial stretching machine that controls the stretching ratio of a film in the widthwise direction, while controlling the length of a film in the lengthwise direction by changing the distance of the gap between clips that hold the opposite ends of the film, for example by using generally known techniques in combination, such as a rail-width control technique, a pantograph technique, a technique of controlling the running speed of a linear motor, etc.

The temperature for the stretching and shrinking treatments is not necessarily limited but can be varied depending on the type of the polymer film. It is preferable to set the temperature according to the glass-transition temperature of the polymer film. Specifically, the temperature for the stretching and shrinking treatments is preferably in the range of plus or minus 30° C., and more preferably plus or minus 20° C., and most preferably plus or minus 10° C., of the glass-transition temperature.

The retardation film of this embodiment can be provided from the polymer film by the aforesaid method, in which the retardation film has a slow axis in the widthwise direction thereof and an Nz coefficient of 0.9-1.1. The retardation film thus obtained is excellent in uniformity of birefringence, retardation, orientation angles or other characteristics, and particularly excellent in uniformity of those characteristics in the widthwise direction. The value of birefringence or retardation of the retardation film varies depending on, for example, the material, the stretching ratio or the like, of the polymer film, but is still excellent in uniformity of those characteristics regardless of the magnitude of birefringence, retardation or the like, provided that the retardation film is manufactured based on the conditions represented by the aforesaid relational expression.

For the retardation film, a variation of the in-plane retardation “(nx−ny)×d” falls preferably within a range of not more than 4%, more preferably within a range of not more than 3.5% and most preferably within a range of not more than 3%. A variation of the thicknesswise retardation “(nx−nz)×d” falls preferably within a range of not more than 5%, more preferably within a range of not more than 4.8% and most preferably within a range of not more than 4.7%. The variation of each retardation can be measured by the following procedure. First, a retardation film is equally divided in the widthwise direction of thereof to have points equally spaced, and the in-plane retardation and thicknesswise retardation at each point are measured. Then, with the average value of them designated as 100%, the absolute value of the difference between the measured value at each point and the average value is calculated as the variation (%) of each of the in-plane retardation and the thicknesswise retardation.

For the retardation film of this embodiment, the variation of the orientation angles in the X axis (the direction of the slow axis) is preferably not more than 2 degrees, more preferably not more than 1.9 degrees and most preferably not more than 1.8 degrees. The above method enables the control of the variation within these ranges and hence achieves improved uniformity of the refractive index. By the orientation angle is meant the angle between the direction of the slow axis and the stretching direction (widthwise direction) at a given point, which angle can be automatically calculated by using an automatic birefringence measuring apparatus (trade name KOBRA-21ADH, manufactured by Oji Scientific Instruments) at a wavelength of 590 nm, in which the aforesaid variation can be represented by the difference between the maximum value and the minimum value in absolute value, such as when the orientation angles were respectively measured at plural points in the same manner as in the measurement for the retardation. In the present invention, the retardation film shows a large variation range in the widthwise direction thereof, which direction thus becomes the direction of the slow axis.

Although the thickness of the thus obtained retardation film varies depending on the thickness, stretching ratio or the like of a polymer film to be used, it is generally within 5-500 μm, preferably within 10-350 μm and more preferably within 20-200 μm.

According to another method of manufacturing the retardation film of this embodiment, a polymer film selected from the norbornene type resin, the polycarbonate type resin and the cellulose type resin is laminated on a substrate to have a laminate, and this laminate is simultaneously subjected to the stretching treatment and the shrinking treatment. In this case, the laminate may be stretched and shrunk with the opposite ends thereof held, or the polymer film may be stretched and shrunk indirectly through a substrate of the laminate, which is stretched and shrunk with the opposite ends of only the substrate held. Alternatively, these treatments may be applied only to the polymer film after it has been released from a substrate.

Now, the description will be made for the case where the polymer film is directly formed on a substrate. First, a resin selected from the norbornene type resin, the polycarbonate type resin and the cellulose type resin is dispersed or dissolved in a solvent to prepare a coating liquid. Although the concentration of the coating liquid is not necessarily limited to a specific concentration, it is preferable to have such as a concentration of the resin preferably in the range of 0.5-50 wt. %, more preferably in the range of 1-40 wt. % and most preferably in the range of 2-30 wt. % for a desirable viscosity allowing easy coating. For example, the amount of the resin to be added is preferably in the range of 5-50 wt. parts and more preferably in the range of 10-40 wt. parts relative to 100 wt. parts of the solvent.

Any type of solvent can be freely selected for the solvent used in the present invention according to the resin to be used, but, for example, a solvent that can solve the resin and is unlikely to wash away a substrate is preferable. Examples of the solvent include: halogenated hydrocarbons such as chloroform, dichloromethane, carbon tetrachloride, dichloroethane, tetrachloroethane, trichloroethylene, tetrachloroethylene, chlorobenzene, orthodichlorobenzene; phenols such as phenol, parachlorophenol; aromatic hydrocarbons such as benzene, toluene, xylene, methoxybenzen, 1,2-dimethoxybenzene; ketone solvent such as acetone, methyl ethyl ketone, methyl isobutyl ketone, cyclohexanone, cyclopentane, 2-pyrolidone, N-methyl-2-pyrolidone; ester solvent such as ethylacetate, butyl acetate; alcohol solvent such as t-butylalcohol, glycerin, ethyleneglycol, triethyleneglycol, ethyleneglycolmonomethylether, diethyleneglycoldimethylether, propylene glycol, dipropylene glycol, 2-methyl-2,4-pentanediol; amide solvent such as dimethylformamide, dimethylacetoamide; nitrile solvent such as acetonitrile, butyronitrile; ether solvent such as diethyl ether, dibutyl ether, tetrahydrofuran; carbon disulfide; ethylcellosolve, butylcellosolve; and sulfuric acid. These may be used alone or in combination of two or more.

Various additives such as surface active agents, stabilizers, plasticizers, metals or the like may be added into the coating liquid according to needs and circumstances.

Another resin may be added into the coating liquid in such a quantity that, for example, the orientation or other properties of a polymer film to be formed on a substrate does not significantly deteriorate. Examples of the resin to be added include various commodity resins, engineering plastics, thermoplastic resins and thermosetting resins.

Examples of the commodity resin include polyethylene (PE), polypropylene (PP), polystyrene (PS), polymethylmethacrylate (PMMA), ABS resin, and AS resin. Examples of the engineering plastics include polyacetate (POM), polyamide (PA: nylon), polyethylene terephthalate (PET) and polybutylene terephthalate (PBT). Examples of the thermoplastic resins include polyphenylene sulfide (PPS), polyethersulfone (PES), polyketone (PK), polyimide (PI), polycyclohexane-dimethanol terephthalate (PCT), polyarylate (PAR) and liquid crystal polymers (LCP). Examples of the thermosetting resins include epoxy resins and phenol novolak resins. When such a resin is added into the coating liquid, the quantity to be added is for example in the range of 0-50 wt. % and preferably in the range of 0-30 wt. %, relative to the aforesaid resin.

Then, the thus prepared coating liquid is applied on a surface of the substrate so as to form a thin coat of polymer film. Examples of the coating techniques of the coating liquid include spin coating, roll coating, printing, dip coating, curtain coating, wire bar coating, doctor blading, knife coating, die coating, gravure coating, micro gravure coating, offset gravure coating, lip coating and spray coating. As for the coating, a polymer layer may be alternatively laminated on the surface of the substrate, according to needs and circumstances.

Although the thickness of the substrate is not necessarily limited, it is generally not less than 10 μm, preferably in the range of 10-200 μm, more preferably in the range of 20-150 μm, and most preferably in the range of 30-100 μm. As long as the thickness is not less than 10 μm, the substrate has a sufficient strength during the later-described stretching and shrinking treatments so that it is possible to satisfactorily prevent the occurrence of uneven application of the stretching and shrinking treatments. When the thickness is not more than 200 μm, the stretching treatment can be made by an appropriate tension force.

Then, the thin coat formed on the substrate is dried. This drying allows the polymer film to be fixed on the substrate so that the polymer film can be directly formed on the substrate.

The drying is not necessarily limited to a specific technique but is achievable by a variety of techniques such as natural drying or heated air drying. The drying conditions may be appropriately determined based on the type of polymer film, the type of solvent or the like. For example, when the heated air drying is made, the temperature for it is generally in the range of 40° C.-250° C., and preferably in the range of 50° C.-200° C. The heated air drying for a thin coat may be made at a constant temperature or alternatively made stepwisely while increasing or decreasing the temperature. Although the time for the heated air drying is also not necessarily limited, it is generally in the range of 10 seconds to 60 minutes, and preferably in the range of 30 seconds to 30 minutes.

After the drying, the solvent left in the polymer film may deteriorate the optical characteristics with age in proportion to its quantity. In light of this, the residual quantity is generally not more than 5%, preferably not more than 2% and most preferably not more than 0.2%.

Although the thickness of a polymer film to be formed on the substrate is not necessarily limited, it is set generally in the range of 0.5-10 μm, preferably in the range of 1-8 μm and more preferably in the range of 1-7 μm.

Then, the polymer film formed on the substrate is simultaneously subjected to the stretching and shrinking treatments under the aforesaid conditions. In this case, the polymer film alone may be directly subjected to the stretching and shrinking treatments, or alternatively a laminate made up of the substrate and the polymer film may be entirely subjected to the stretching and shrinking treatments. The stretching and shrinking treatments are preferably made by first laminating a polymer film on a substrate to have a laminate and then holding the opposite ends of the substrate of the laminate. This is because the polymer film formed on the substrate can be evenly subjected to the stretching and shrinking treatments by allowing only the substrate to be subjected to these stretching and shrinking treatments.

When formed on a substrate in the manner described above, the retardation film of this embodiment may be used in the form of a laminate made up with the substrate or in the form of a single layer after removed from the substrate. The retardation film may be used in such a form obtained by removing a film from the substrate (hereinafter referred to a first substrate) and then again laminating or transferring the same on another substrate (hereinafter referred to a second substrate), which does not deteriorate the optical characteristics of the film, via an adhesive layer.

The second substrate is not necessarily limited to a specific material, provided that it has an appropriate planarity. For example, glass, polymer film that is transparent and has optical isotropy, or the like is preferable. Examples of the polymer film include a film made of polymethyl methacrylate, polystyrene, polycarbonate, polyether sulfone, polyphenyl sulfide, polyarylate, amorphous polyolefin, triacetyl cellulose (TAC), epoxy resin, or a resin composition containing an alternating copolymer of isobutene and N-methyl maleimide and an acrylonitrile-styrene copolymer. Of them, preferable are polymethyl methacrylate, polycarbonate, polyarylate, triacetyl cellulose (TAC), polyether sulfone, and a resin composition containing an alternating copolymer of isobutene and N-methyl maleimide and an acrylonitrile-styrene copolymer. Even a substrate having optical anisotropy may be used, depending on the intended use. Examples of such a substrate having optical anisotropy include a retardation film or a polarizing film formed by stretching a polymer film of such as polycarbonate, polystyrene or norbornene type resin.

As an adhesive of an adhesive layer to be formed for the above mentioned transferring, any adhesive may be used, provided that it can be used for the optical use. Specifically, acrylic adhesive, epoxy adhesive or urethane adhesive is usable.

Now, the description will be made for a polarizing plate of this embodiment.

The polarizing plate is prepared by dyeing a polyvinyl alcohol (PVA) based film with iodine or the like and uniaxially stretching the same. Specifically, the polyvinyl alcohol type film is dipped in a dying bath with iodine and dyed, and subsequently stretched 3-7 times its original length. Thus, the polarizing plate is prepared. Before dyeing, a polyvinyl alcohol type film may be dipped in water and washed, according to needs and circumstances. This washing allows dirt or an antiblocking agent deposited on a surface of the polyvinyl alcohol type film to be cleaned, while allowing the polyvinyl alcohol type film to be swollen so as to be effective in preventing ununiformity such as ununiform dyeing. The film may be stretched after dyed with iodine, or may be stretched while dyed with iodine. Alternatively, the film may be stretched even in an aqueous solution of boric acid or potassium iodide or in a water bath.

The polarizing plate is preferably made of a combination of a polyvinyl alcohol type film (preferably a polyvinyl alcohol film) and a dichroic substance such as iodine. The thickness of the polarizing plate is not necessarily limited. Generally, the thickness of the polarizing plate is selected to be in the range of 5 μm-80 μm.

In general, the polarizing plate made of the polyvinyl alcohol type film can have an absorption axis in the lengthwise direction and a transmission axis in a direction substantially perpendicular to the absorption axis by the stretching in the lengthwise direction.

The retardation-film integrated polarizing plate of the present invention can be manufactured by arranging a retardation film and a polarizing plate so as to respectively have a slow axis and an absorption axis crossing each other substantially at right angles. In general, the slow axis of the retardation film corresponds to its stretching direction, while the absorption axis of the polarizing plate corresponds to its stretching direction. The retardation film of this embodiment is manufactured by applying the stretching treatment to a film in the widthwise direction, while at the same time moving the film in the lengthwise direction so as to have it rolled up to have a rolled retardation film. The rolled retardation film thus has a slow axis corresponding to the stretching direction. A polarizing plate is also rolled up while at the same time being subjected to the stretching treatment in the lengthwise direction. When the rolled retardation film and the rolled polarizing plate are to be laminated together, they are respectively fed from the rolls so as to have their side edges parallel to the lengthwise direction being overlapped to each other, and successively laminated together (so called roll to roll lamination).

When a retardation-film integrated polarizing plate with the retardation film and the polarizing plate laminated by the roll to roll lamination is manufactured, they are laminated to each other with the slow axis of the retardation film oriented at 90 degrees plus or minus 5 degrees to the absorption axis of the polarizing plate. With the angle being at 90 degrees plus or minus 5 degrees, it is possible to enhance the display quality (front contrast and contrast at oblique viewing angles, etc.) of an LCD device with the thus obtained retardation-film integrated polarizing plate used therein.

For preparation of a retardation-film integrated polarizing plate by the lamination of the retardation film and the polarizing plate, adhesive or the like may be used for lamination. Examples of the adhesive include polymeric pressure sensitive adhesive such as of acrylic type, vinyl alcohol type, silicone type, polyester type, polyurethane type or polyether type, and rubber type pressure sensitive adhesive. It is also possible to use adhesive made of an aqueous crosslinker of a vinyl alcohol-based polymer such as glutaraldehyde, melamine or oxalic acid. Of them, it is preferable to use adhesive of the type that is hard to be influenced by temperature or heat and therefore hard to be removed, and provides high transmittance and high polarization degree. Specifically, when the polarizing plate is made of a polyvinyl alcohol type film, it is preferable to use polyvinyl alcohol type adhesive because of its high stability during a bonding treatment, or the like.

The retardation-film integrated polarizing plate of the present invention is preferably used to form various devices such as an LCD device. For example, a polarizing plate is disposed on one side or both sides, of a liquid crystal cell to provide a liquid crystal panel to be used in an LCD device. Thus, the LCD device can have the enhanced front contrast and the enhanced contrast at oblique viewing angles.

The LCD device is not particularly limited in type. For example, the LCD device may be formed as any type system such as an active matrix drive system, for example, using TFT (thin-film transistor) electrode or a MIM (Metal Insulator Metal) electrode, an IPS (in-plane switching) system, a PALC (plasma addressed liquid crystal display), a simple-matrix driving type represented by an TN (twisted nematic) type or an STN (super twisted nematic) type, or other types. Specific examples of the liquid crystal cell include a STN (super twisted nematic) cell, a TN (twisted nematic) cell, an IPS (in-plane switching) cell, a VA (vertical nematic) cell, an OCB (optically controlled birefringence) cell, a HAN (hybrid aligned nematic) cell, an ASM (axially symmetric aligned microcell) cell, a ferroelectric or antiferroelectric cell, and those to which orientation division was made in regular random order.

An LCD device with the retardation-film integrated film of the present invention may be of a transmission type with a backlight system, a reflection type with a reflection plate, or a projection type.

The retardation-film integrated polarizing plate of the present invention may be applied to display devices other than the above-described LCD device, such as an EL (organic electroluminescence) display, a PDP (plasma display panel) and an FED (field emission display) or other light-emitting display devices.

### EXAMPLES

Now, the description will be made for the present invention in more specific manner, with reference to Examples and Comparative Examples. It is to be noted that the present invention is not limited to these Examples. The respective characteristics were measured by the following procedures.

(Measurement of the Retardation and the Orientation Angular Distribution)

The retardation and the orientation angular distribution were measured at a wavelength of 590 nm by using an automatic birefringence analyzer (trade name KOBRA-21ADH, manufactured by Oji Scientific Instruments).

(Measurement of the Film Thickness)

The thickness of a retardation film was measured by using an instaneous multi-photometric system (trade name MCPD-2000, manufactured by Otsuka Denshi Co., Ltd.).

### Example 1

A retardation film (thickness: 97 μm) was prepared by successively stretching a non-stretched norbornene-type film (trade name ZEONOR, manufactured by JSR Corporation) having a thickness of 100 μm and a width of 600 mm in the widthwise direction, while at the same time shrinking the same in the lengthwise direction, by using a high-performance thin-film machine (trade name FITZ, manufactured by K.K. Ichikin Kogyo-sha). The stretching temperature, the STD in the widthwise direction and the SMD in the lengthwise direction were respectively set at 135° C., 1.25 times and 0.90 times. By using an automatic birefringence measuring apparatus (trade name KOBRA-21ADH, manufactured by Oji Scientific Instruments), the in-plane retardation (Δnd=(nx−ny)×d), the thicknesswise retardation (Rth=(nx−nz)×d), and the orientation angular distribution, of the thus obtained retardation film were measured at nine points in 50 mm intervals so as to be bilaterally symmetric in the widthwise direction. With respect to the in-plane retardation and the thicknesswise retardation, each average value was first calculated and then an NZ coefficient was calculated from the average value. The results are shown in Table 1.

The retardation film was laminated with a polarizing plate (trade name SEG1425DU, manufactured by Nitto Denko Corporation) so as to have the slow axis oriented at 90 degrees to the absorption axis of the polarizing plate. Herein, nx, ny and nz respectively represent refractive indices of the retardation film in an X-axis (slow axis) direction, a Y-axis direction and a Z-axis direction, in which the X-axis direction corresponds to an in-plane axis direction to give a maximum refractive index, the Y-axis direction corresponds to an in-plane axis direction vertical to the X-axis, the Z-axis direction corresponds to a thickness direction vertical to the X-axis and the Y-axis, and d represents a thickness of the retardation film.

### Example 2

A retardation film (thickness: 94 μm) was prepared in the same manner as Example 1 except that the SMD in the lengthwise direction was set at 0.93 times. For the thus obtained retardation film, the in-plane retardation, etc., were measured in the same manner as Example 1. The results are shown in Table 1. The thus prepared retardation film was laminated with a polarizing plate in the same manner as Example 1.

### Example 3

A retardation film (thickness: 82 μm) was prepared in the same manner as Example 1 by using a non-stretched cellulose type film (trade name KA film, manufactured by Kaneka Corporation) having a thickness of 96 μm and a width of 600 mm. For the thus prepared retardation film, the in-plane retardation, etc., were measured in the same manner as Example 1. The results are shown in Table 1. The thus prepared retardation film was laminated with a polarizing plate in the same manner as Example 1. The stretching temperature, the STD in the widthwise direction and the SMD in the lengthwise direction were respectively set at 160° C., 1.5 times and 0.82 times.

### Comparative Example 1

A retardation film (thickness: 90 μm) was prepared in the same manner as Example 1 except that the SMD in the lengthwise direction was set at 0.95 times. For the thus obtained retardation film, the in-plane retardation, etc., were measured in the same manner as Example 1. The results are shown in Table 1. The retardation film was laminated with a polarizing plate in the same manner as Example 1.

### Comparative Example 2

A retardation film (thickness: 84 μm) was prepared in the same manner as Example 1 except that the SMD in the lengthwise direction was set at 1.00 times. For the thus obtained retardation film, the in-plane retardation, etc., were measured in the same manner as Example 1. The results are shown in Table 1. The retardation film was laminated with a polarizing plate in the same manner as Example 1.

### Comparative Example 3

A retardation film (thickness: 72 μm) was prepared in the same manner as Example 3 by using a cellulose type film of Example 3 except that the SMD in the lengthwise direction was set at 1.00 times. For the thus obtained retardation film, the in-plane retardation, etc., were measured in the same manner as Example 1. The results are shown in Table 1. The retardation film was laminated with a polarizing plate in the same manner as Example 1.

### Comparative Example 4

A retardation film (thickness: 78 μm) was prepared in the same manner as Example 3 by using a cellulose type film of Example 3 except that the SMD in the lengthwise direction was set at 0.95 times. For the thus obtained retardation film, the in-plane retardation, etc., were measured in the same manner as Example 1. The results are shown in Table 1. The retardation film was laminated with a polarizing plate in the same manner as Example 1.

TABLE 1

| | | | STD | | SMD | | |
|---|---|---|---|---|---|---|---|
| | | STRETCHING | STRETCHING | | STRETCHING | Δnd (NM) | |
| | | TEMPERATURE | RATIO | (1/STD)^{1/2} | RATIO | AVERAGE | DISTRIBUTION |
| | FILM | (° C.) | (TIMES) | VALUE | (TIMES) | VALUE | *1 |
| EXAMPLE 1 | NORBORNENE | 135 | 1.25 | 0.894 | 0.90 | 110.4 | 3.2 |
| | TYPE | | | | | | |
| EXAMPLE 2 | NORBORNENE | 135 | 1.25 | 0.894 | 0.93 | 103.2 | 2.5 |
| | TYPE | | | | | | |
| EXAMPLE 3 | CELLULOSE | 160 | 1.5 | 0.816 | 0.82 | 97.0 | 3.5 |
| | TYPE | | | | | | |
| COMPARATIVE | NORBORNENE | 135 | 1.25 | 0.894 | 0.95 | 83.5 | 8.5 |
| EXAMPLE 1 | TYPE | | | | | | |
| COMPARATIVE | NORBORNENE | 135 | 1.25 | 0.894 | 1.00 | 65.7 | 8.8 |
| EXAMPLE 2 | TYPE | | | | | | |
| COMPARATIVE | CELLULOSE | 160 | 1.5 | 0.816 | 1.00 | 37.1 | 6.1 |
| EXAMPLE 3 | TYPE | | | | | | |
| COMPARATIVE | CELLULOSE | 160 | 1.5 | 0.816 | 0.95 | 59.4 | 7.5 |
| EXAMPLE 4 | TYPE | | | | | | |

| | | | ORIENTATION | | |
|---|---|---|---|---|---|
| | Rth (NM) | | ANGULAR | Nz | |
| | AVERAGE | DISTRIBUTION | DISTRIBUTION | COEFFICIENT | THICKNESS |
| | VALUE | *1 | (°) *1 | (Rth/Δnd) | (μm) |
| EXAMPLE 1 | 107.7 | 5.1 | 1.8 | 0.98 | 97 |
| EXAMPLE 2 | 107.2 | 4.8 | 1.5 | 1.04 | 94 |
| EXAMPLE 3 | 102.1 | 4.5 | 1.7 | 1.05 | 82 |
| COMPARATIVE | 101.3 | 10.2 | 2.5 | 1.21 | 90 |
| EXAMPLE 1 | | | | | |
| COMPARATIVE | 119.8 | 12 | 3.5 | 1.82 | 84 |
| EXAMPLE 2 | | | | | |
| COMPARATIVE | 91.9 | 10.2 | 4.3 | 2.48 | 72 |
| EXAMPLE 3 | | | | | |
| COMPARATIVE | 139.4 | 11.5 | 2.9 | 2.35 | 78 |
| EXAMPLE 4 | | | | | |

*1: “Distribution” means max-min.

(Evaluation of a Retardation Film in Actual Use)

Each of the retardation films obtained in Examples and Comparative Examples is mounted in a liquid crystal cell to prepare a liquid crystal panel, and the difference in brightness in a white display state and a black display state, that is, the front contrast and the contrast at oblique viewing angles were measured. The front contrast was measured by using a luminance colorimeter (trade name BM-5A, manufactured by TOPCON CORPORATION) and the contrast at oblique viewing angles (polar angle: 60 degrees fixed, azimuth: average of 45 degrees and 135 degrees) was measured by using an EZ contrast 160D manufactured by ELDIM SA.

(Evaluation Test 1)

A retardation film 20 obtained in Example 2 was laminated with a polarizing plate 10 (trade name SEG1425DU, manufactured by Nitto Denko Corporation) via adhesive to have the slow angle of the retardation film 20 crossing at right angles to the absorption axis of the polarizing plate 10 to provide a first laminate. Then, a liquid crystal cell 30 (a liquid crystal cell taken out from a 26 inches liquid crystal monitor, manufactured by Sharp Kabushiki Kaisha) was laminated via its surface (viewing surface) on a surface (a surface on which the polarizing plate is not laminated) of the retardation film 20 of the laminate with adhesive. A retardation film 40 (trade name NAB-EF-SEG, manufactured by Nitto Denko Corporation, Δnd=0 nm, Rth=120 nm) is laminated with a polarizing plate 50 (trade name SEG1425DU, manufactured by Nitto Denko Corporation) via adhesive to provide a second laminate, which is in turn laminated on the opposite surface of the liquid crystal cell 30 (the side on which a backlight was installed) via a surface of the retardation film 40, on which the polarizing plate 50 is not laminated. Thus, a liquid crystal panel was obtained.

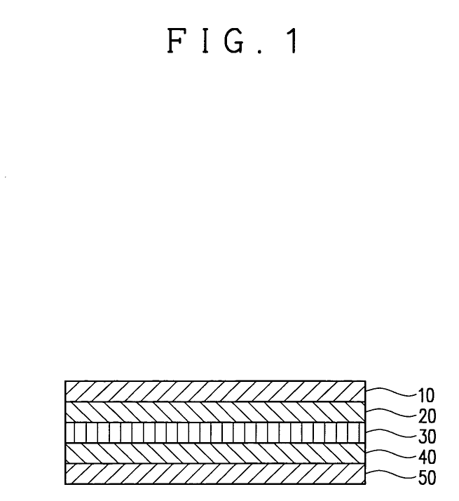

The retardation film 40 (trade name NAB-EF-SEG, manufactured by Nitto Denko Corporation) was laminated with the polarizing plate 50 (trade name SEG1425DU, manufactured by Nitto Denko Corporation) to have the slow axis oriented at 90 degrees to the absorption axis in a VA mode. FIG. 1 illustrates a cross sectional view of the thus obtained liquid crystal panel. The lamination of the respective members was made by using acrylic pressure sensitive adhesive (thickness: 20 μm). The front contrast and the contrast at the oblique viewing angle, of the liquid crystal panel were respectively 580 and 28.

(Evaluation Test 2)

A liquid crystal panel was obtained in the same manner as Evaluation Test 1 by using a retardation film obtained in Comparative Example 1. The front contrast and the contrast at the oblique viewing angle, of the liquid crystal panel were respectively 450 and 15.

Table 2 shows the combined results of Evaluation Tests 1 and 2.

TABLE 2

| | | RESULTS OF THE | |
|---|---|---|---|
| | | EVALUATION | |
| | | | CONTRAST AT |
| | FILM IN | FRONT | OBLIQUE |
| | ACTUAL USE | CONTRAST | VIEWING ANGLE |
| EVALUATION | EXAMPLE 2 | 580 | 28 |
| TEST 1 | | | |
| EVALUATION | COMPARATIVE | 450 | 15 |
| TEST 2 | EXAMPLE 1 | | |

It was found from the evaluation results that the image display quality (the front contrast and the contrast at oblique viewing angles) is enhanced.

This specification is by no means intended to restrict the present invention to the preferred embodiments set forth therein. Various modifications to the retardation-film integrated polarizing plate and the method of manufacturing the same, as described herein, may be made by those skilled in the art without departing from the spirit and scope of the present invention as defined in the appended claims.

What is claimed is:

1. A retardation-film integrated polarizing plate comprising a polarizing plate stretched in a lengthwise direction thereof and having an absorption angle in said lengthwise direction, and a uniaxial retardation film having a slow axis in a widthwise direction thereof and an Nz coefficient of 0.9-1.1, in which the polarizing plate is laminated with the uniaxial retardation film so as to have the slow axis of the retardation film oriented at an angle of 90 degrees plus or minus 5 degrees to the absorption axis of the polarizing plate.

2. The retardation-film integrated polarizing plate according to claim 1, wherein an in-plane retardation And of the retardation film is 10-590 nm.

3. The retardation-film integrated polarizing plate according to claim 1, wherein said retardation film contains any one of polycarbonate type resin, norbornene type resin and cellulose type resin.

4. The retardation-film integrated polarizing plate according to claim 1, wherein said retardation film comprises any one of a single layer thereof and a laminate that is made up of said retardation film and a substrate on which said retardation film is laminated.

5. A method of manufacturing a retardation-film integrated polarizing plate, comprising laminating a uniaxial retardation film having a slow axis in a widthwise direction thereof and an Nz coefficient of 0.9-1.1, with a polarizing plate stretched in a lengthwise direction thereof and having an absorption axis in said lengthwise direction so as to have opposite lateral sides of the retardation film respectively positioned parallel to opposite lateral sides of the polarizing plate, thereby allowing the slow axis of the retardation film to be oriented at an angle of 90 degrees plus or minus 5 degrees to the absorption axis of the polarizing plate.
